(19) United States
(12) Patent Application Publication
(10) Pub. No.: US 2006/0114760 A1
(43) Pub. Date: Jun. 1, 2006

(54) Information recording/reproducing apparatus and method of controlling the same

(75) Inventors: Yuuichi Togashi, Tokyo (JP); Takayuki Nakashima, Ome-shi (JP); Yoshihiro Katayama, Saitama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/256,160

(22) Filed: Oct. 24, 2005

(30) Foreign Application Priority Data
Nov. 30, 2004 (JP) 2004-347748

(51) Int. Cl. G11B 21/08

(52) U.S. Cl. 369/30.01; 369/47.1

(57) ABSTRACT

An information recording/reproducing apparatus comprises a control unit, a memory unit, and a display output unit. The control unit sub-classifies causes of errors into an item dependent on the standard of the recording medium, an item dependent on the use purpose, recorded information and the like to indicate them when errors are detected during recording/reproducing of information on/from the information recording medium. Accordingly, the apparatus can display in detail the causes of the errors generated during the recording/reproducing of the information on/from the recording medium.

### CROSS-REFERENCE TO RELATED APPLICATIONS

This application is based upon and claims the benefit of priority from prior Japanese Patent Application No. 2004-347748, filed Nov. 30, 2004, the entire contents of which are incorporated herein by reference.

### BACKGROUND OF THE INVENTION

1. Field of the Invention

The present invention relates to an information recording/reproducing apparatus capable of recording and reproducing information, and more particularly to an information recording/reproducing apparatus capable of displaying, in detail, causes of errors which occur during recording/reproducing of information on/from a recording medium.

2. Description of the Related Art

An optical disk has widely been used as a recording medium suited to the recording of digital information

Meanwhile, optical disks of various standards have been proposed and put to practical use.

For example, optical disks are classified into those of CD and DVD standards in terms of recording capacity, and appearances thereof are almost similar except for displayed label surfaces or the like.

In terms of purpose (type), optical disks are classified into a read-only type (ROM) on which information has been recorded, a write-once (recordable) type, (R) on which information can be recorded only once, a rewritable (recording/reproducing) type (RAM or RW) capable of repeated recording and deleting, and the like. Each of the recordable and rewritable types is sub-classified in accordance with recording speed during recording.

The sub-classification of the types of the optical disks causes diversification of errors generated during information recording/reproducing on/from the optical disk into a type dependent on disk standard, a type dependent on purpose, a type dependent on recorded information, and the like.

Thus, even if an error message is displayed, for example, work of discovering its cause based on the user's experience, replacing the disk by another optical disk, or the like is necessary.

Jpn. Pat. Appln. KOKAI Publication No. 2000-331411 has proposed an optical disk recording apparatus for notifying, without recording, a user that a loaded optical disk is determined to be a disk incapable of correct recording.

Jpn. Pat. Appln. KOKAI Publication No. 2003-338169 has proposed an optical disk apparatus capable of informing whether an inserted optical disk is writable or not based on the flashing period or lighting pattern of an LED.

In the case of the optical disk apparatus disclosed in the Publication No. 2000-331411, there is a limit on types of errors to be displayed, causing a problem of incomplete displaying of error causes when there are various types of optical disks like today.

Thus, it is difficult to determine the cause of an error to be a scratch or a defect of the optical disk, an optical disk unsupported by the disk drive (information recording/reproducing apparatus) or file system, an unsupported format, or the like.

### BRIEF SUMMARY OF THE INVENTION

An aspect of the present invention provides an information recording/reproducing apparatus which records information on a recording medium or reproduces information recorded on the recording medium, comprising:

means for detecting an occurrence of an error caused by the recording medium during the recording of the information on the recording medium or the reproducing of the information from the recording medium;

means for judging a cause of the error detected by the detecting means; and

means for outputting an output which displays a result of the judgment with the judging means on a display unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing an example of a configuration of an information recording/reproducing apparatus according to an embodiment of the present invention;

FIG. 2 is a flowchart showing a flow from detection to displaying of various errors likely to occur in the information recording/reproducing apparatus shown in FIG. 1;

FIG. 3 is a schematic diagram showing an example of a message to be displayed in the flow shown in FIG. 2;

FIG. 4 is a schematic diagram showing an example of a message to be displayed in the flow shown in FIG. 2;

FIG. 5 is a schematic diagram showing an example of a message to be displayed in the flow shown in FIG. 2;

FIG. 6 is a schematic diagram showing an example of a message to be displayed in the flow shown in FIG. 2;

FIG. 7 is a schematic diagram showing an example of a message to be displayed in the flow shown in FIG. 2;

FIG. 8 is a schematic diagram showing an example of a message to be displayed in the flow shown in FIG. 2;

FIG. 9 is a schematic diagram showing an example of a message to be displayed in the flow shown in FIG. 2;

FIG. 10 is a schematic diagram showing an example of a message to be displayed in the flow shown in FIG. 2; and

FIG. 11 is a schematic diagram showing an example of a message displayed with respect to an error whose cause a user can eliminate.

### DETAILED DESCRIPTION OF THE INVENTION

Hereinafter, the preferred embodiment of the present invention will be described with reference to the accompanying drawings.

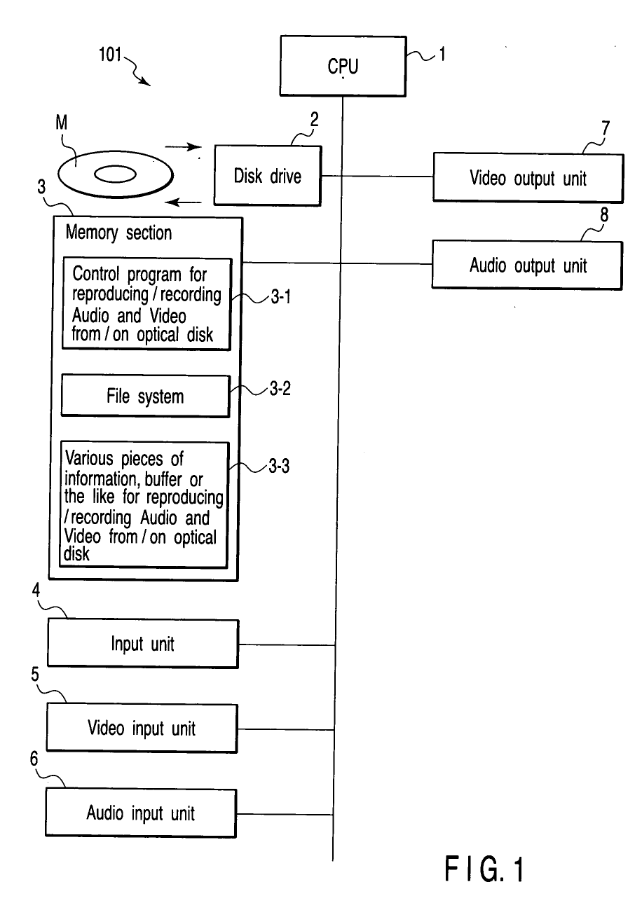

FIG. 1 is a block diagram illustrating a configuration of an embodiment of the present invention.

An information recording/reproducing apparatus 101 shown in FIG. 1 can record input information on a predetermined recording medium, and has an information recording/reproducing section (disk drive) 2 capable of reproducing recorded information in accordance with a reproducing operation, and a microcomputer (main control unit, referred to as a CPU hereinafter) 1 for controlling recording of information on an optical disk (recording medium) M loaded in the disk drive 2, reproducing of recorded information from the optical disk M, and operations of sections described below.

A memory section 3, an input unit 4, a video input unit 5, an audio input unit 6, a video output unit 7, an audio output unit 8, and the like are connected to the CPU 1 via a control bus and a data bus (not described in detail).

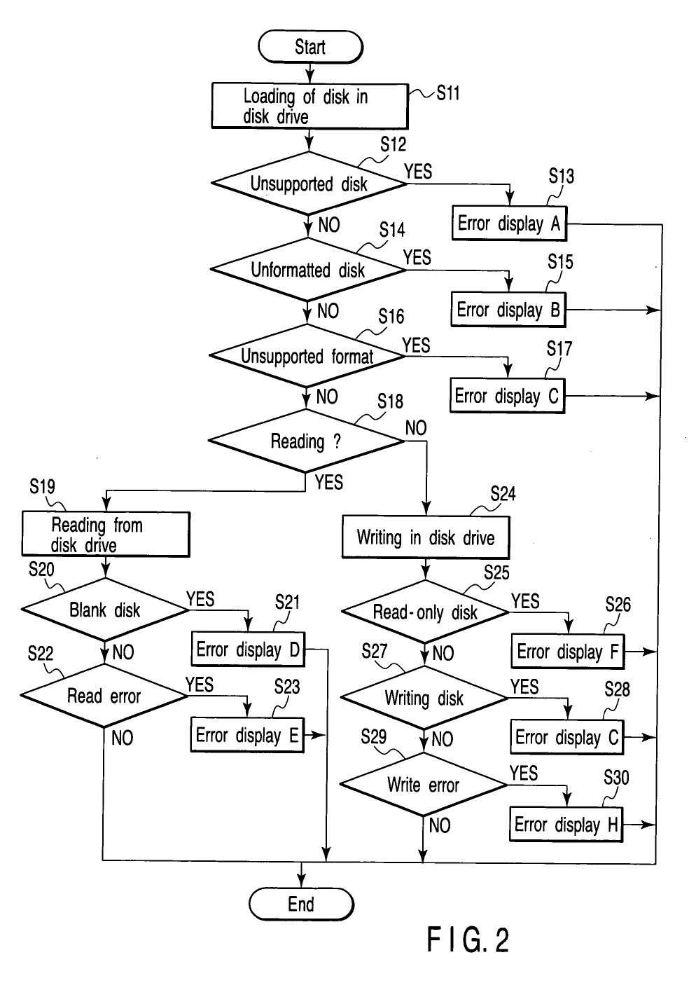

The CPU 1 executes a program stored in the memory section 3. The CPU 1 also functions as a disk determination section used for specifying a standard and a type of an optical disk (described later) or detecting various errors (described below with reference to FIG. 2).

The disk drive 2 records data corresponding to information to be recorded on, or reproduces recorded data from recording media M, i.e., various standards or types of optical disks such as CD, CD-R, CD-RW, DVD, DVD-R, DVD-RW, DVD+R, DVD+RW, DVD-RAM, and HD DVD.

The memory section 3 includes, e.g., a ROM and a RAM, and holds a program or data used by the apparatus 101. The memory section 3 includes a control program 3-1 for reproducing information read from the disk drive 2, or recording image data and voice data supplied via the video input unit 5 and the audio input unit 6 on an optical disk loaded in the disk drive 2, a file system 3-2 used for reading/writing data with the disk drive 2, and various pieces of information or a buffer 3-3 necessary for reproducing a recorded image or voice from the optical disk, or recording an image or a voice on the optical disk.

The control program 3-1 is recorded on, e.g., the ROM, and referred to by the CPU 1 or firmware of the disk drive 2, for example, at the time of detecting or determining:

whether a recording medium is unsupported or not, or unformatted or not,

whether a format is unsupported or not, whether a recording medium of a data reproducing target is an clank disk or not,

whether a read error has occurred or not, or that read information is incomplete,

that a recording medium of a data write target is a read-only,

that there is no writable region in the recording medium of a data write target,

whether a write error has occurred or not, or the like.

The input unit 4 is represented by a keyboard, a mouse, a button (including control key or pad form), a remote control terminal (generally called a remote controller, not shown), or the like, and used for instructing the apparatus 101, i.e., inputting a control signal or data.

The video input unit 5 receives, e.g., a video signal supplied through broad casting or cable system via a tuner, and auxiliary video signal or the like. Similarly, the audio input unit 6 receives, e.g., an audio signal via the tuner, and an auxiliary audio signal or the like.

The video output unit 7 is a display unit represented by a liquid crystal display (LCD), a surface field emission type display (SED) or the like, or an output terminal represented by a video output (video, s-video or D terminal), and used for displaying images reproduced by the disk drive 2, or images to be recorded on the optical disk M by the disk drive 2, outputting a video signal therefor, and displaying information necessary for user interface (UI), or outputting a signal which can be displayed.

The audio output unit 8 has a speaker or an audio sound output terminal, and is used for reproducing an audio reproduced from or to be recorded on the optical disk M, or outputting an audio signal therefor, and the audio or the like to be recorded on the optical disk M on a monitor, or outputting sound effects or the like.

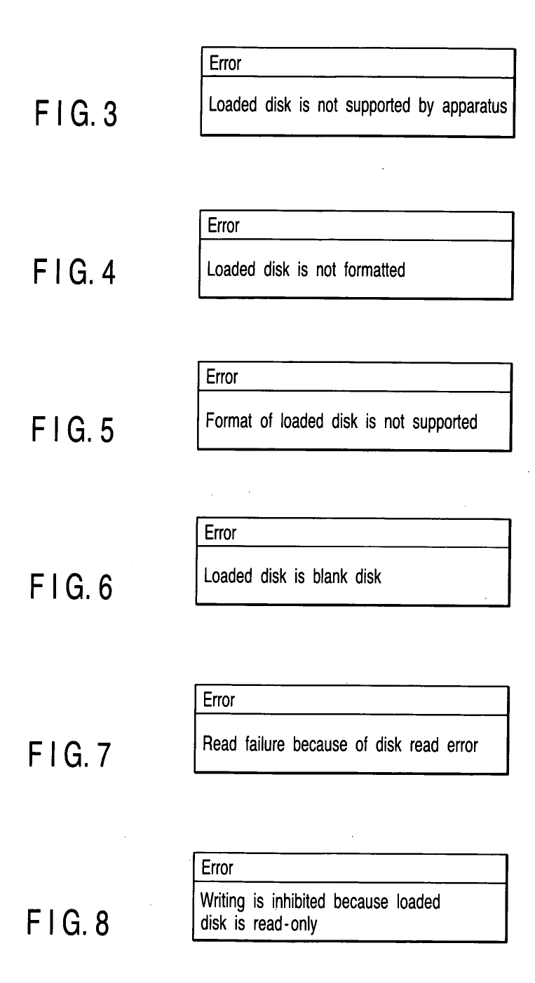

FIG. 2 shows an example of a flow from detection to displaying of various errors generated in the information recording/displaying apparatus shown in FIG. 1. It is to be noted that examples of error displaying in S13, S15, S17, S21, S23, S28 and S30 are shown in FIGS. 3 to 10.

First, the optical disk (recording medium) M is loaded in the disk drive 2 (S11).

Hereinafter, judgment is made as to whether the set optical disk M is an “unsupported optical disk” or not, i.e., whether a standard of the disk can be handled or not by the apparatus 101 (S12).

During the judgment, for example, at least items dependent on the disk standard or items dependent on purposes are captured by the firmware of the disk drive 2.

Thus, for example, when no information is obtained from the recording medium (optical disk) because the disk is inserted inside out or the like, “display” of “disk cannot be recognized” or the like may be made before a routine of judgment as to contents of information or the like recorded in the disk is started by the CPU 1. For message displaying, for example, in many cases, a “display pattern” or a “corresponding message” prerecorded in the ROM of the memory section 3, an error message holding section (not shown) or the firmware of the CPU 1 is selected under control of the CPU 1, and the video output unit 7 is instructed to display the message.

In this case, the displayed message is displayed on a display section when the display section of the information recording/reproducing apparatus 101 includes a LCD panel or a LED array of a dot matrix type capable of displaying optional character strings (not described in detail). When on-screen displaying widely used today is allowed, an image display signal is output to a connected CRT monitor (television receiver), surface field emission type display (SED) or the like to display the message.

A displayed image or a change pattern is prepared beforehand in a font ROM or a nonvolatile memory (not described in detail) of the memory section 3, or the firmware of the CPU 1. Each displayed character or image can be optionally changed based on displaying of a menu prepared beforehand or a plurality of displayed patterns defined to be selected by a user.

Signal processing for displaying the message on the apparatus main body 101 is similar throughout contents of errors described below. Thus, in description of each error, explanation of a method of displaying an error message will be omitted.

If a result of judgment in step S12 is an unsupported optical disk, message displaying is instructed to display “error display A” exemplarily shown in FIG. 3 (S13).

If a supported optical disk is judged in step S12, judgment is made as to whether a set optical disk is formatted or not, i.e., whether a standard of the disk can be handled or not by the apparatus 101, or whether it is initialized or not (S14).

If a result of the judgment in step S14 is an unformatted optical disk, message displaying is instructed to display “error display B” exemplarity shown in FIG. 14 (S15).

If the result of the judgment in step S14 is a formatted disk, judgment is made as to whether the set optical disk has an unsupported format or not, i.e., whether a format can be dealt with or not by the apparatus 101 while a standard of the disk can be handled by the apparatus and is formatted (S16).

If a result of judgment in step S16 is an unsupported format, message displaying is instructed to display “error display C” exemplarily shown in FIG. 5 (S17).

If result of the judgment in the step S16 is a supported format, judgment is made as to reading (reproducing) of information recorded in the disk, i.e., playing of a recorded disk, or writing (recording) in a recordable disk (S18).

In step S18, if writing is instructed in a set state of a rewritable optical disk, new information may be written in recorded information by mistake (information not to be deleted is deleted by mistake). Thus, priority is given to reading in many cases.

If a result of the judgment in step S18 is reading (Yes in S18), among pieces of information recorded on the optical disk M loaded in the drive 2, information recorded in a well-known lead-in region or lead-out region prepared irrespective of disk types is read (S19).

Based on the information read in step S19, judgment is made as to whether the optical disk is an blank disk or not (S20).

If a result of the judgment in step S20 is an unused optical disk, message displaying is instructed to display “error display D” exemplarily shown in FIG. 6 (S21).

If the result of the judgment in the step S20 is not an unused optical disk, judgment is made as to correct reading (whether a read error occurs or not) in step S19 (S22).

If a result of the judgment in the step S22 is a read error, message displaying is instructed to display “error display E” exemplarily shown in FIG. 7 (S23).

In step S22, the read information may be partially or all reproduced, or a file for checking may be reproduced to check no damage of the read information.

If a result of the judgment in step S22 is no error, the process is finished.

On the other hand, if the result of the judgment in step S18 is writing (No in S18), writing of information in the optical disk set in the drive 2 is loaded (S24).

Then, judgment is made as to whether the optical disk of the writing target in step S24 is a read-only optical disk or not (S25).

If a result of the judgment in step S25 is a read-only disk (Yes in S25), message displaying is instructed to display “error display F” exemplarily shown in FIG. 8 (S26).

If the result of the judgment in step S25 is an optical disk other than a read-only optical disk, judgment is made as to whether the optical disk of the writing target in S25 is an optical disk which enables writing only once (recordable or write-once type) and writing has been finished (finalized), or it is a rewritable optical disk (recording/reproducing type, i.e., rewritable type) and information has been written in all the regions (there is no writable region) (S27).

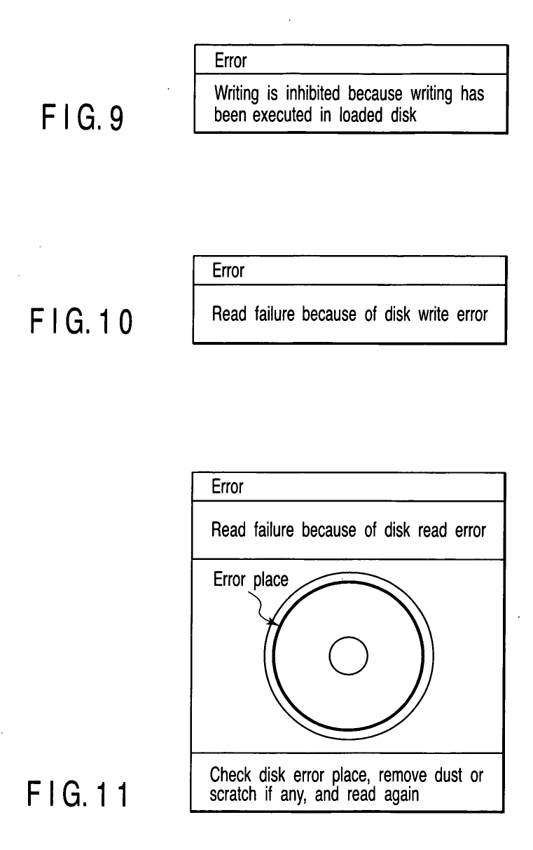

If a result of the judgment in step S27 is the optical disk which enables writing only once, and writing has been finished (or rewritable type, but there is no writable region) (Yes in S27), message displaying is instructed to display “error display G” exemplarily shown in FIG. 9 (S28).

If the result of the judgment in step S27 is the optical disk which enables writing only once, and writing is allowed, or there is a writable region left in the rewritable optical disk (No in S27), judgment is made as to whether a write error has occurred or not (S29).

If the occurrence of “write error” is judged in step S29, message displaying is instructed to display “error display H” exemplarily shown in FIG. 10 S30).

If a correct end of the writing is judged in step S29, the process is finished.

If an error occurs to display “error display E” in step S22 or an error occurs to display “error display H” in step S29, a foreign object (dirt or dust) stuck to the disk as a cause of the error can be removed. Thus, by removing the foreign object, reproducing or recording may be possible.

Accordingly, as an error message, “error display (graphics)” exemplarily shown in FIG. 11 may be prepared to visually display a position judged to be an error on the optical disk. Contents to be displayed may be simple, for example, so that the user can recognize a position in which dirt, dust, a scratch or the like is judged to be present.

If it is judged from the graphics of FIG. 11 that the user can remove the cause of the error, it is possible to prevent an error (by cleaning or the like).

An error position to be displayed can be easily specified (displayed) based on a sector number of an error occurrence, time information obtained thus far by reproduction, or the like.

That is, according to the information recording/reproducing apparatus and its control method of the present invention, it is announced what is a cause of an error. Namely, there is announced any of various causes, for example,

whether a recording medium is unsupported or not,

whether it is unformatted or not,

whether a format is unsupported or not,

whether a recording medium of a playing target is a blank disk or not,

whether a read error occurs or not, or that read information is incomplete,

that a recording medium of a writing target is read-only,

that there is no writable region in the recording medium of the writing target, and

whether a write error occurs or not.

When a read or write error occurs, its position can be displayed if it is attributed to the recording medium. The error can be prevented if the cause can be removed.

As described above, according to the information recording/reproducing apparatus of the present invention, if some kind or another error occurs during recording/reproducing of information on/from the optical disk, error causes can be sub-classified into an item dependent on the standard of the disk, an item dependent on the purpose, recorded information, and the like to be specified. Thus, an error state is made clear, and the load on the user is reduced.

Furthermore, for an error which can be prevented by handling of the user, information can be additionally displayed to facilitate dealing with the error. Thus, depending on an error situation, recovery can be made easily by the user, increasing convenience.

The present invention is not limited to the embodiments described above and can be modified in various manners without departing from the spirit and scope of the invention.

For example, the present invention can provide:

A method of controlling an information reproducing apparatus, comprising:

detecting whether a standard of a set recording medium is supported or not;

detecting whether the recording medium is formatted or not, when the standard is detected to be supported;

detecting whether a format thereof is supported or not, when the recording medium is detected to be formatted;

detecting whether the recording medium is unused or not;

detecting a possibility of reading information when the recording medium is determined to be unused;

sequentially checking readability of all pieces of information when the possibility of reading the information is determined; and

stopping reproduction from the recording medium to announce a cause of an error when the error is detected somewhere.

The present invention can also provide:

A method of controlling an information recording/reproducing apparatus, comprising:

detecting whether a set recording medium is supported or not;

detecting whether the recording medium is formatted or not, when a standard of the recording medium is detected to be supported;

detecting whether a format thereof is supported or not, when the recording medium is detected to be formatted;

detecting whether the recording medium is recordable or not;

detecting whether a recordable region remains or not, when the recording medium is determined to be recordable;

detecting whether information instructed to be written is written or not; and

stopping reproduction from the recording medium to announce a cause of an error when the error is detected somewhere.

What is claimed is:

1. An information recording/reproducing apparatus which records information on a recording medium or reproduces information recorded on the recording medium, comprising:
means for detecting an occurrence of an error caused by the recording medium during the recording of the information on the recording medium or the reproducing of the information from the recording medium;
means for judging a cause of the error detected by the detecting means; and
means for outputting an output which displays a result of the judgment with the judging means on a display unit.

2. The information recording/reproducing apparatus according to claim 1, wherein the judging means judges whether the recording medium is supported or not.

3. The information recording/reproducing apparatus according to claim 1, wherein the judging means judges whether the recording medium is formatted or not.

4. The information recording/reproducing apparatus according to claim 1, wherein the judging means judges whether a format of the recording medium is supported or not.

5. The information recording/reproducing apparatus according to claim 1, wherein the judging means judges whether an optical disk (recording medium) is an unused disk or not.

6. The information recording/reproducing apparatus according to claim 1, wherein the judging means judges the occurrence of the error during reading.

7. The information recording/reproducing apparatus according to claim 1, wherein the judging means judges whether the recording medium is a writable medium or not, when writing is instructed.

8. The information recording/reproducing apparatus according to claim 1, wherein the judging means judges whether there is a writable region or not, when writing is instructed.

9. The information recording/reproducing apparatus according to claim 1, wherein the judging means judges the occurrence of the error during writing.

10. The information recording/reproducing apparatus according to claim 1, further comprising:
means for specifying a position on the recording medium to obtain an occurrence position of an error on the recording medium when the judging means judges the occurrence of the error during reading or writing; and
means for adding a signal which displays the occurrence position of the error on the recording medium to the signal output by the outputting means.

11. A method of controlling an information recording/reproducing apparatus, comprising:
detecting whether a set recording medium is based on a standard to be handled or not;
detecting whether the recording medium is formatted or not, when the recording medium is detected to be based on the standard to be handled;
detecting whether it is possible or not to handle a format thereof when the recording medium is detected to be formatted;
detecting presence of recorded information;
detecting a success or a failure (right or wrong) of reading of the information when the recorded information is reproduced; and
stopping the reproduction of the information from the recording medium to announce a cause of an error when the error is detected somewhere.

12. The method according to claim 11, further comprising:
detecting whether a reading error or a writing error is caused by a foreign object stuck to the recording medium, a scratch or the like to schematically display a position of the cause on the recording medium, when the error is detected.

13. A method of controlling an information recording/reproducing apparatus, comprising:
detecting whether a set recording medium is based on a standard to be handled or not;
detecting whether the recording medium is formatted or not, when the recording medium is detected to be based on the standard to be handled;
detecting whether it is possible or not to handle a format thereof, when the recording medium is detected to be formatted;
detecting whether the recording medium is recordable or not;
detecting whether a recordable recording region remains or not;
detecting whether information instructed to be written is written or not; and
stopping recording on the recording medium to announce a cause of an error when the error is detected somewhere.

14. The method according to claim 13, further comprising:
detecting whether a reading error or a writing error is caused by a foreign object stuck to the recording medium, a scratch or the like to schematically display a position of the cause on the recording medium, when the error is detected.
